(19) United States
(12) Patent Application Publication
(10) Pub. No.: US 2024/0195090 A1
(43) Pub. Date: Jun. 13, 2024

(54) TERMINAL BLOCK

(71) Applicant: SUMITOMO WIRING SYSTEMS, LTD., Mie (JP)

(72) Inventor: Risato TAKADA, Mie (JP)

(21) Appl. No.: 18/286,551

(22) PCT Filed: Apr. 26, 2022
(86) PCT No.: PCT/JP2022/018884

§ 371 Date: Oct. 11, 2023

(30) Foreign Application Priority Data
Apr. 27, 2021 (JP) 2021-075174

(51) Int. Cl. H01R 9/22; H01R 9/18; H01R 9/24; H01R 11/26; H01R 43/24; H01R 105/00

(52) U.S. Cl. CPC H01R 9/223; H01R 9/18; H01R 9/2416; H01R 11/26; H01R 43/24; H01R 2105/00

(57) ABSTRACT

A terminal block according to one aspect of the present disclosure is provided with a plurality of terminals, a bracket and a housing made of resin. Each of the terminals includes a first connecting portion projecting from the housing and a second connecting portion projecting toward a side opposite to the first connecting portion from the housing. The bracket includes a fixing portion projecting from the housing and to be fixed to a case. Each of the first connecting portions includes a connection hole, into which a bolt is inserted. The fixing portion includes a fixing hole, into which a bolt is inserted. An axial direction of each connection hole and that of the fixing hole coincide. The bending stiffness of the fixing portion is smaller than that of each of the first connecting portions.

### TECHNICAL FIELD

The present disclosure relates to a terminal block.

### BACKGROUND

Conventionally, a relay member is known which connects a lead wire extending from a coil of a motor and a mating terminal provided in a case of the motor (see, for example, Patent Document 1). A relay member described in Patent Document 1 includes a flexible member to be joined to the lead wire and a terminal to be coupled to the flexible member and connected to the mating terminal.

In connecting the terminal to the mating terminal, the flexible member is deformed, thereby absorbing tolerances between the terminal and the mating terminal.

### PRIOR ART DOCUMENT

### Patent Document

Patent Document 1: JP 2005-229753 A

### SUMMARY OF THE INVENTION

### Problems to be Solved

A terminal block obtained by integrating a plurality of terminals and a housing made of resin by insert molding may be used as a relay member. In such a terminal block, the housing is preferably fixed to a case to suppress the vibration of the terminal block. In this case, since the terminals are connected to mating terminals and the housing is fixed to the case, a gap may be formed between the terminal block and the case due to manufacturing tolerances and assembling tolerances. Thus, it is desired to absorb tolerances between the terminal block and the case.

The present disclosure aims to absorb tolerances between a terminal block and a case.

### Means to Solve the Problem

The present disclosure is directed to a terminal block for electrically connecting a plurality of mating terminals provided in a case of a device and a plurality of electrically conductive members, the terminal block being provided with a plurality of terminals made of a metal plate for electrically connecting each of the plurality of mating terminals and each of the plurality of electrically conductive members, a bracket made of a metal plate, the bracket being fixed to the case, and a housing made of resin, the plurality of terminals and the bracket being embedded in the housing, each of the plurality of terminals including a first connecting portion projecting from the housing and to be connected to the mating terminal and a second connecting portion projecting toward a side opposite to the first connecting portion from the housing and to be connected to the electrically conductive member, the bracket including a fixing portion projecting from the housing and to be fixed to the case, the first connecting portion including a connection hole, a bolt used for connection to the mating terminal being inserted into the connection hole, the fixing portion including a fixing hole, a bolt used for fixing to the case being inserted into the fixing hole, an axial direction of the connection hole and that of the fixing hole coinciding, and bending stiffness of the fixing portion being smaller than that of each of a plurality of the first connecting portions.

### Effect of the Invention

According to the present disclosure, tolerances between a terminal block and a case can be absorbed.

### BRIEF DESCRIPTION OF THE DRAWINGS

FIG. 1 is a perspective view showing a terminal block and a case of one embodiment.

FIG. 2 is a perspective view showing the case.

FIG. 3 is a perspective view showing the terminal block.

FIG. 4 is a plan view showing the terminal block.

FIG. 5 is a section along 5-5 of FIG. 4.

FIG. 6 is a section along 6-6 of FIG. 4.

FIG. 7 is a section showing a manufacturing apparatus before molds are clamped.

FIG. 8 is a section showing the manufacturing apparatus after the molds are clamped.

### DETAILED DESCRIPTION TO EXECUTE THE INVENTION

### Description of Embodiments of Present Disclosure

First, embodiments of the present disclosure are listed and described.
[1] The terminal block of the present disclosure is a terminal block for electrically connecting a plurality of mating terminals provided in a case of a device and a plurality of electrically conductive members, and provided with a plurality of terminals made of a metal plate for electrically connecting each of the plurality of mating terminals and each of the plurality of electrically conductive members, a bracket made of a metal plate, the bracket being fixed to the case, and a housing made of resin, the plurality of terminals and the bracket being embedded in the housing, each of the plurality of terminals including a first connecting portion projecting from the housing and to be connected to the mating terminal and a second connecting portion projecting toward a side opposite to the first connecting portion from the housing and to be connected to the electrically conductive member, the bracket including a fixing portion projecting from the housing and to be fixed to the case, the first connecting portion including a connection hole, a bolt used for connection to the mating terminal being inserted into the connection hole, the fixing portion including a fixing hole, a bolt used for fixing to the case being inserted into the fixing hole, an axial direction of the connection hole and that of the fixing hole coinciding, and bending stiffness of the fixing portion being smaller than that of each of a plurality of the first connecting portions.

According to this configuration, since the axial direction of the connection hole and that of the fixing hole coincide, an attachment direction of the terminal to the mating terminal and that of the bracket to the case coincide.

Here, the bending stiffness of the fixing portion is smaller than that of each of the plurality of first connecting portions. Thus, even if a gap is formed between the fixing portion and the case when the first connecting portion is connected to the mating terminal by the bolt, the fixing portion is easily deformed toward the case by fastening the bolt inserted through the fixing hole to the case. Therefore, tolerances between the terminal block and the case can be absorbed.
[2] Preferably, a thickness of the fixing portion is smaller than that of each of the plurality of first connecting portions.

According to this configuration, the bending stiffness of the fixing portion can be easily made smaller than that of each of the plurality of first connecting portions.
[3] Preferably, if a projecting direction of the plurality of first connecting portions is a first direction and a direction intersecting the first direction is a second direction, the plurality of first connecting portions are juxtaposed with each other in the second direction and the plurality of second connecting portions are juxtaposed with each other in the second direction.

According to this configuration, the size of the terminal block in the third direction orthogonal to both the first and second directions can be reduced.
[4] Preferably, the first and second connecting portions in each of the plurality of terminals are provided at positions different from each other in the second direction.

According to this configuration, even if the position of each mating terminal and that of each electrically conductive member are different in the second direction, these can be electrically connected by the terminal block.
[5] Preferably, a plurality of the brackets are provided.

According to this configuration, the terminal block can be stably fixed to the case as compared to the case where the terminal block is fixed to the case by only one bracket. Therefore, the vibration of the terminal block with respect to the case can be suppressed.
[6] Preferably, if a direction orthogonal to both the first and second directions is a third direction, the first connecting portion includes a first projecting direction projecting in the first direction from the housing and a first extending portion bent from the first projecting direction and extending in the third direction, the fixing portion includes a second projecting portion projecting in a plane direction orthogonal to the third direction from the housing and a second extending portion bent from the second projecting portion and extending toward a side opposite to the first extending portion in the third direction, and the second projecting portion includes a through portion penetrating in the third direction.

According to this configuration, the second extending portion of the bracket extends toward the side opposite to the first extending portion of the first connecting portion of the terminal in the third direction. Here, in insert-molding the terminal block, the terminal may be positioned with respect to a fixed mold by inserting the first extending portion into a recess of the fixed mold. In this case, since the second extending portion extends toward a side away from the fixed mold in the third direction, it is difficult to position the bracket with respect to the fixed mold. Thus, the bracket is easily shifted in position with respect to the fixed mold. Such a problem is particularly notable in an apparatus in which inertial forces and vibration act on the terminals and the bracket arranged in the fixed mold according to a movement of the fixed mold, for example, like a rotary injection molding apparatus.

In this respect, according to the above configuration, the second projecting portion includes the through hole penetrating in the third direction. In this way, the bracket can be easily positioned with respect to the fixed mold by providing the fixed mold with a support pin to be inserted into the through portion. In this way, the aforementioned inconvenience can be avoided.

Further, since the second projecting portion is provided with the through portion according to the above configuration, the bending stiffness of the bracket is reduced and the bracket is easily deformed toward the case. Therefore, an operation of attaching the terminal block to the case can be smoothly performed.

### Details of Embodiment of Present Disclosure

A specific example of a terminal block of the present disclosure is described below with reference to the drawings. In each figure, some components may be shown in an exaggerated or simplified manner for the convenience of description. Further, a dimension ratio of each part may be different in each figure. Note that the present disclosure is not limited to these illustrations, but is represented by claims and intended to include all changes in the scope of claims and in the meaning and scope of equivalents. “Parallel” and “orthogonal” in this specification mean not only strictly parallel and orthogonal, but also substantially parallel and orthogonal within a range in which functions and effects in this embodiment are achieved.

### (Configuration of Terminal Block 10)

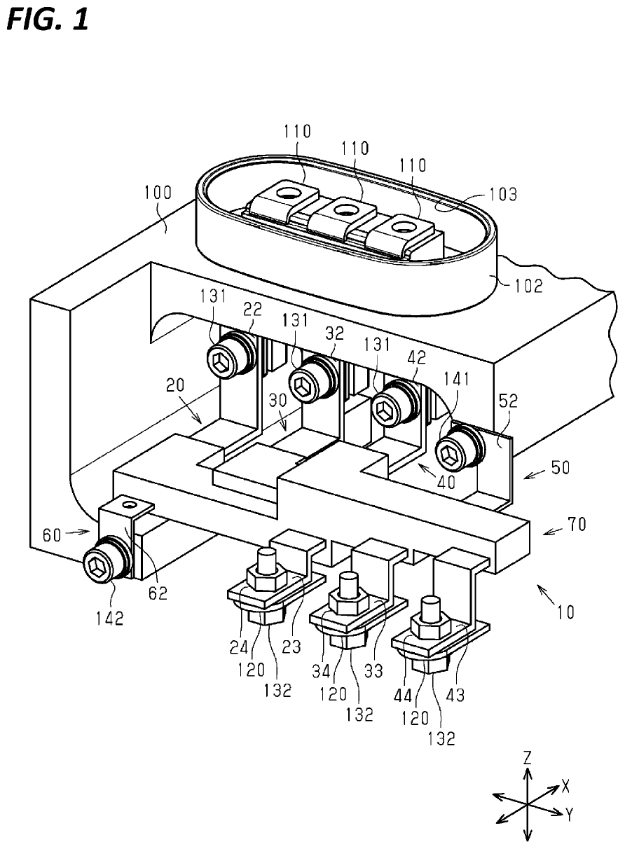

As shown in FIG. 1, the terminal block 10 is, for example, for electrically connecting a plurality of mating terminals 110 provided in a case 100 of a device such as a motor and a plurality of electrically conductive members 120. In this embodiment, three mating terminals 110 and three electrically conductive members 120 are electrically connected by the terminal block 10.

The terminal block 10 is provided with a plurality of terminals 20, 30 and 40, a plurality of brackets 50, 60 to be fixed to the case 100 and a housing 70 made of resin. The respective terminals 20, 30 and 40, the respective brackets 50, 60 and the housing 70 are integrated by insert molding. The respective terminals 20, 30 and 40 and the respective brackets 50, 60 are partially embedded in the housing 70. The terminal block 10 is fixed to the case 100 by the respective brackets 50, 60.

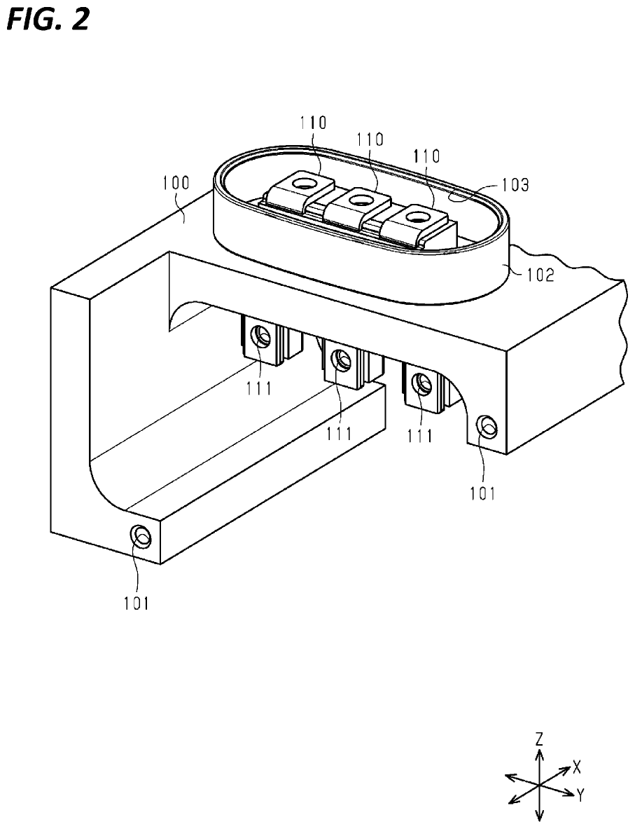

As shown in FIGS. 1 and 2, the case 100 includes two screw holes 101, into which two bolts 141, 142 for fixing the terminal block 10 to the case 100 are tightened. Axial directions of the two screw holes 101 coincide. The case 100 is, for example, formed of a metal material such as aluminum alloy.

The mating terminal 110 is, for example, L-shaped. The mating terminal 110 is integrally provided in a resin member 102 penetrating from the inside to the outside of the case 100. One end of the mating terminal 110 is located inside the case 100. The other end of the mating terminal 110 is exposed to the outside of the case 100 through an opening 103 provided in the resin member 102. The one end of the mating terminal 110 includes an insertion hole 111, into which a bolt 131 for fixing each terminal 20, 30, 40 is inserted. Out of the inside of the case 100, a part adjacent to the one end of each mating terminal 110 in a plate thickness direction is provided with a nut located coaxially with the insertion hole 111 and to be fastened to the bolt 131. An axial direction of each insertion hole 111 and that of each screw hole 101 coincide.

The electrically conductive members 120 are, for example, lead wires for supplying power to the coil of the motor. The lead wires are flexible. Only connection terminals constituting the tips of the lead wires are shown in FIG. 1.

### (Configurations of Terminals 20, 30, 40)

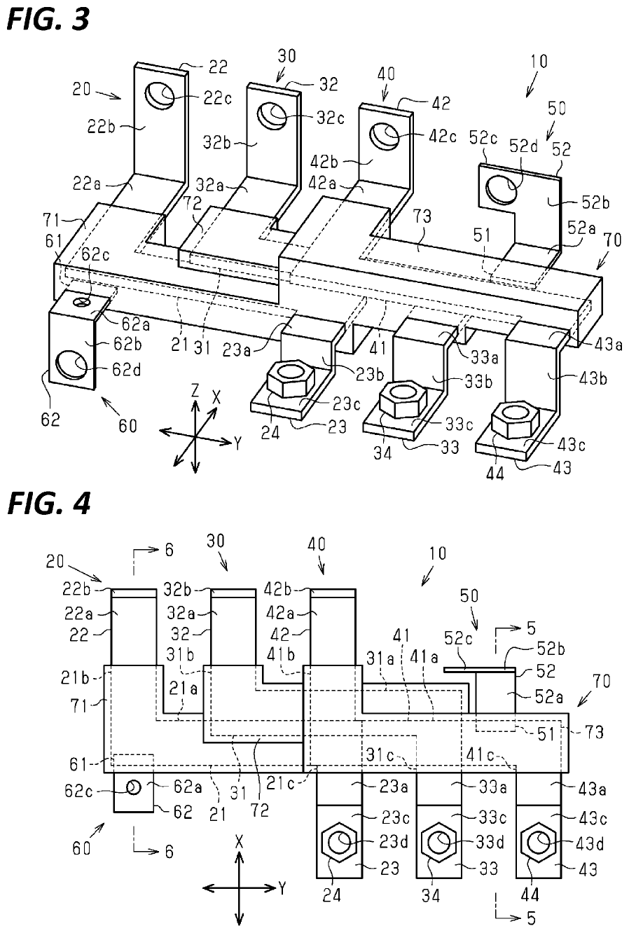

As shown in FIGS. 3 and 4, the terminals 30, 40 have a structure common to that of the terminal 20. Thus, the configuration of the terminal 20 is described in detail below. For the structures of the terminals 30 and 40, components are denoted by reference signs “3*” and “4*” obtained by adding “10” and “20” to reference signs “2*” indicating components of the terminal 20, whereby repeated description may be omitted.

The terminal 20 is formed by bending a metal plate. The terminal 20 is, for example, formed of a copper-based or aluminum-based metal material. The terminal 20 of this embodiment is formed of a copper-based metal material.

The terminal 20 includes an embedded portion 21 embedded in the housing 70, a first connecting portion 22 projecting from the housing 70 and a second connecting portion 23 projecting toward a side opposite to the first connecting portion 22 from the housing 70. The first connecting portion 22 is connected to one end of the embedded portion 21. The second connecting portion 23 is connected to the other end of the embedded portion 21. As shown in FIG. 1, the first connecting portion 22 is connected to the mating terminal 110 by the bolt 131. The second connecting portion 23 is connected to the electrically conductive member 120 by a bolt 132.

As shown in FIG. 4, a plurality of first connecting portions 22, 32, and 42 are juxtaposed with each other in a direction orthogonal to a projecting direction thereof. The plurality of first connecting portions 22, 32, and 42 are parallel. A plurality of second connecting portions 23, 33 and 43 are juxtaposed with each other in a direction orthogonal to a projecting direction thereof. The plurality of second connecting portions 23, 33 and 43 are parallel.

Hereinafter, the projecting direction of each first connecting portion 22, 32, 42 is referred to as a first direction X. The direction orthogonal to the first direction X is referred to as a second direction Y. A direction orthogonal to both the first and second directions X, Y is referred to as a third direction Z. Note that the second direction Y is a direction in which the plurality of first connecting portions 22, 32 and 42 are juxtaposed with each other and the plurality of second connecting portions 23, 33 and 43 are juxtaposed with each other.

The first and second connecting portions 22, 23 are provided at positions different from each other in the second direction Y.

The embedded portion 21 includes a straight portion 21a extending in the second direction Y, a first coupling portion 21b connected to the first connecting portion 22 and a second coupling portion 21c connected to the second connecting portion 23.

The first coupling portion 21b is bent from one end of the straight portion 21a and extends toward the first connecting portion 22 in the first direction X. The second coupling portion 21c is bent from the other end of the straight portion 21a and extends toward the second connecting portion 23 in the first direction X.

As shown in FIG. 3, the first connecting portion 22 includes a projecting portion 22a projecting toward one side in the first direction X from the housing 70 and an extending portion 22b bent from the projecting portion 22a and extending toward one side in the third direction Z. Each projecting portion 22a, 32a, 42a corresponds to the first projecting portion in the [Description of Embodiments of Present Disclosure]. Each extending portion 22b, 32b, 42b corresponds to the first extending portion in the [Description of Embodiments of Present Disclosure].

The first connecting portion 22 includes a connection hole 22c, into which the bolt 131 used for connection to the mating terminal 110 is inserted. The connection hole 22c penetrates through the extending portion 22b in the first direction X.

The second connecting portion 23 includes a projecting portion 23a projecting toward the other side opposite to the one side in the first direction X from the housing 70, an extending portion 23b bent from the projecting portion 23a and extending toward the other side opposite to the one side in the third direction Z and an extending portion 23c bent from the extending portion 23b and extending toward the other side in the first direction X.

The projecting portion 23a projects toward a side opposite to the projecting portion 22a in the first direction X from the housing 70. The extending portion 23b extends toward a side opposite to the extending portion 22b in the third direction Z from the projecting portion 23a. The extending portion 23c extends toward a side opposite to the projecting portion 23a in the first direction X from the extending portion 23b.

As shown in FIG. 4, the second connecting portion 23 includes a connection hole 23d, into which the bolt 132 used for connection to the electrically conductive member 120 is inserted. The connection hole 23d penetrates through the extending portion 23c in the third direction Z. A nut 24, into which the bolt 132 is tightened, is mounted on one surface in the third direction Z of the extending portion 23c. The nut 24 is provided coaxially with the connection hole 23d.

Next, points of differences of the terminals 30, 40 from the terminal 20 are described with reference to FIGS. 3 and 4.

A first coupling portion 31b of the terminal 30 is shorter than the first coupling portion 21b of the terminal 20. A second coupling portion 31c of the terminal 30 is longer than the second coupling portion 21c of the terminal 20. An extending portion 33b of the terminal 30 is longer than the extending portion 23b of the terminal 20. An embedded portion 31 of the terminal 30 is provided at a position separated from the embedded portion 21 of the terminal 20 by a length difference between the extending portions 33 and 23b in the third direction Z.

An extending portion 43b of the terminal 40 is longer than the extending portion 23b of the terminal 20. Note that the extending portion 43b of the terminal 40 is longer than the extending portion 33b of the terminal 30. An embedded portion 41 of the terminal 40 is provided at a position separated from the embedded portion 21 of the terminal 20 by a length difference between the extending portions 43b and 23b in the third direction Z.

The respective extending portions 23c, 33c and 43c are provided at the same position in the third direction Z.

### (Configuration of Bracket 50)

As shown in FIG. 3, the bracket 50 is formed by bending a metal plate. The bracket 50 is, for example, formed of an iron-based or aluminum-based metal material. The bracket 50 of this embodiment is formed of an iron-based metal material.

The bracket 50 includes an embedded portion 51 embedded in the housing 70 and a fixing portion 52 projecting from the housing 70. The fixing portion 52 is connected to the embedded portion 51. As shown in FIG. 1, the fixing portion 52 is fixed to the case 100 by a bolt 141. The fixing portion 52 projects toward the same side as the first connecting portion 22 in the first direction X from the housing 70.

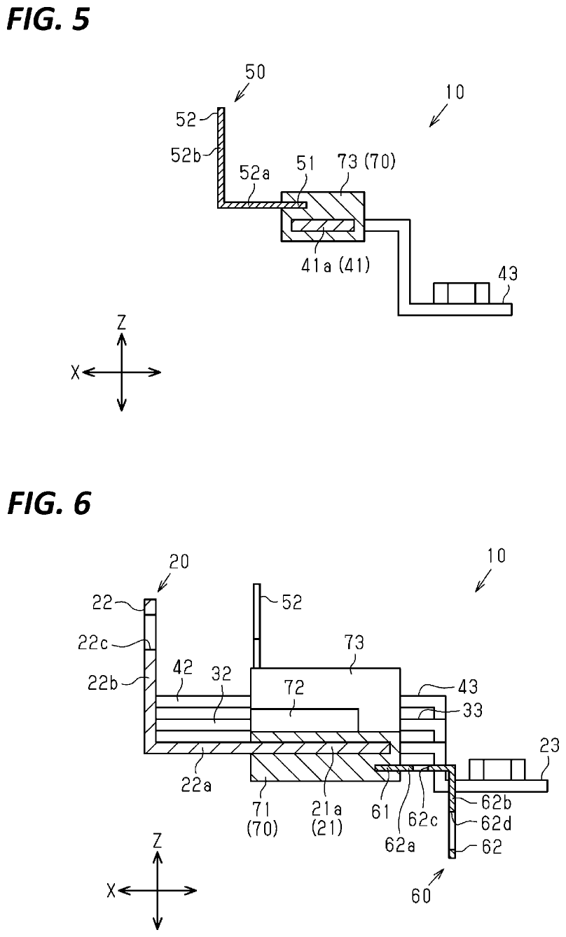

As shown in FIG. 4, the embedded portion 51 is located between the second connecting portions 33 and 43 in the second direction Y. As shown in FIG. 5, the embedded portion 51 is located further on the one side in the third direction Z than the embedded portion 41 of the terminal 40.

As shown in FIG. 3, the fixing portion 52 includes a projecting portion 52a projecting toward the one side in the first direction X from the housing 70, an extending portion 52b bent from the projecting portion 52a and extending toward the one side in the third direction Z and an extending portion 52c bent from the extending portion 52b and extending toward the one side in the second direction Y.

The projecting portion 52a projects toward the same side as the projecting portion 22a of the first connecting portion 22 in the first direction X from the housing 70. The extending portion 52c extends toward the respective terminals 20, 30 and 40 in the second direction Y from the extending portion 52b. A length of the extending portion 52b is larger than that of the projecting portion 52a.

The fixing portion 52 includes a fixing hole 52d, into which the bolt 141 used for fixing to the case 100 is inserted. The fixing hole 52d penetrates through the extending portion 52c in the first direction X. That is, the axial direction of each connection hole 22c, 32c, 42c and that of the fixing portion 52d coincide.

A thickness of the bracket 50 is smaller than that of each of the terminals 20, 30 and 40. In this way, the bending stiffness of the fixing portion 52 is smaller than that of each of the terminals 20, 30 and 40.

In this embodiment, with the respective terminals 20, 30 and 40 connected to the respective mating terminals 110, a projecting amount of the fixing portion 52 from the housing 70 is set to form a gap between the fixing portion 52 and the case 100. Thus, the fixing portion 52 is fixed to the case 100 while being slightly deformed toward the case 100. The fixing portion 52 of this embodiment is fixed to the case 100 while being plastically deformed. Note that the fixing portion 52 may be fixed to the case 100 while being resiliently deformed.

### (Configuration of Bracket 60)

The bracket 60 is formed by bending a metal plate. The bracket 60 is, for example, formed of an iron-based or aluminum-based metal material. The bracket 60 of this embodiment is formed of an iron-based metal material.

The bracket 60 includes an embedded portion 61 embedded in the housing 70 and a fixing portion 62 projecting from the housing 70. The fixing portion 62 is connected to the embedded portion 61. As shown in FIG. 1, the fixing portion 62 is fixed to the case 100 by a bolt 142. The fixing portion 62 projects toward a side opposite to the first connecting portion 22, i.e. toward the same side as the second connecting portion 23, in the first direction X from the housing 70.

As shown in FIG. 4, the embedded portion 61 is located at a position overlapping the first connecting portion 22 in the second direction Y. As shown in FIG. 6, the embedded portion 61 is located further on the other side in the third direction Z than the embedded portion 21 of the terminal 20.

As shown in FIG. 3, the fixing portion 62 includes a projecting portion 62a projecting toward the other side in the first direction X from the housing 70 and an extending portion 62b bent from the projecting portion 62a and extending toward the other side in the third direction Z.

The projecting portion 62a projects toward a side opposite to the projecting portion 22a of the first connecting portion 22, i.e. toward the same side as the projecting portion 23a of the second connecting portion 23, in the first direction X from the housing 70. A length of the extending portion 62b is larger than that of the projecting portion 62a.

The fixing portion 62 includes a through hole 62c penetrating through the projecting portion 62a in the third direction Z. The through hole 62c corresponds to the through portion in the [Description of Embodiments of Present Disclosure].

The fixing portion 62 includes a fixing hole 62d, into which the bolt 142 used for fixing to the case 100 is inserted. The fixing hole 62d penetrates through the extending portion 62b in the first direction X. That is, the axial direction of each connection hole 22c, 32c, 42c and that of the fixing portion 62d coincide. Therefore, the axial direction of the fixing hole 62d also coincides with that of the fixing hole 52d in the bracket 50.

A thickness of the bracket 60 is smaller than that of each of the terminals 20, 30 and 40. In this way, the bending stiffness of the fixing portion 62 is smaller than that of each of the terminals 20, 30 and 40. Note that the thickness of the bracket 60 is, for example, equal to that of the thickness 50.

In this embodiment, with the respective terminals 20, 30 and 40 connected to the respective mating terminals 110, a projecting amount of the fixing portion 62 from the housing 70 is set to form a gap between the fixing portion 62 and the case 100. Thus, the fixing portion 62 is fixed to the case 100 while being slightly deformed toward the case 100. The fixing portion 62 of this embodiment is fixed to the case 100 while being plastically deformed. Note that the fixing portion 62 may be fixed to the case 100 while being resiliently deformed.

### (Configuration of Housing 70)

The housing 70 is, for example, formed of a resin material such as a thermoplastic resin.

The housing 70 includes a first holding portion 71 for holding the embedded portion 21, a second holding portion 72 for holding the embedded portion 31 and a third holding portion 73 for holding the embedded portion 41. The respective holding portions 71 to 73 are integrally formed. The respective holding portions 71 to 73 cover the entire outer peripheries of the respective embedded portions 21, 31 and 41.

Note that the bracket 50 projects from the third holding portion 73. The bracket 60 projects from the first holding portion 71.

### (Manufacturing Procedure of Terminal Block 10)

Further, a manufacturing apparatus 200 used in manufacturing the terminal block 10 is described.

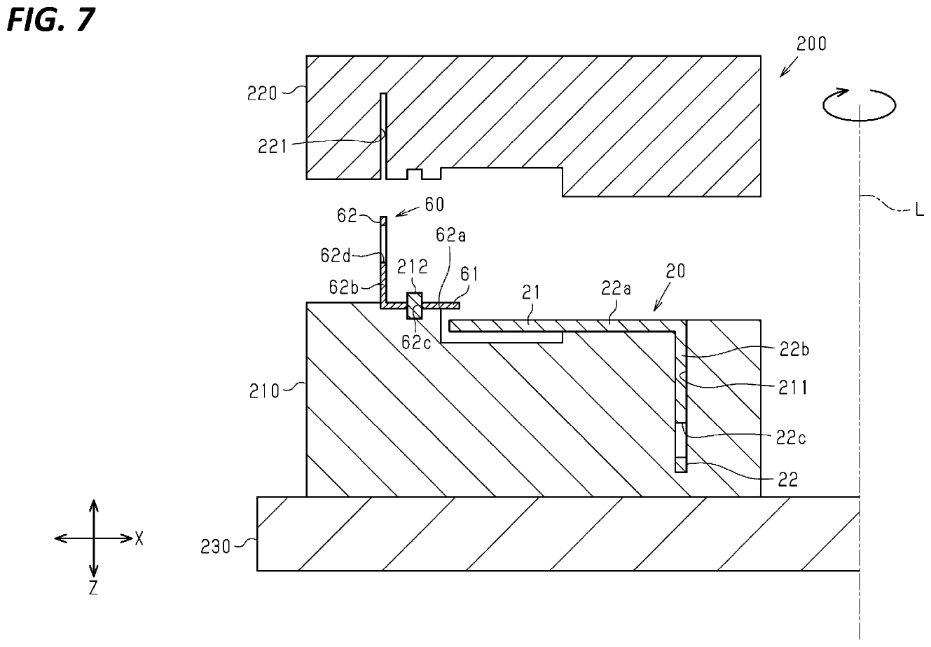

As shown in FIG. 7, the manufacturing apparatus 200 is provided with a fixed mold 210, a movable mold 220 provided to be able to advance and retreat with respect to the fixed mold 210 and a rotary table 230 configured to be rotatable about an axis of rotation L. The manufacturing apparatus 200 is a so-called rotary injection molding apparatus.

The fixed mold 210 is installed on a part of an outer peripheral side of the axis of rotation L on the rotary table 230. The fixed mold 210 is configured to be movable in a circumferential direction about the axis of rotation L with respect to the movable mold 220 according to the rotation of the rotary table 230.

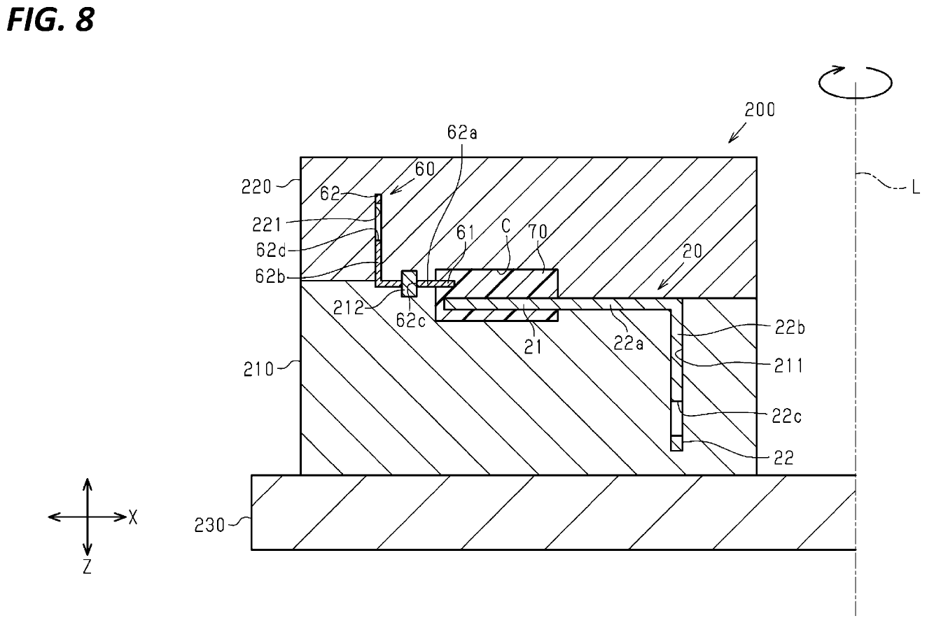

As shown in FIG. 8, a cavity C is formed between the fixed mold 210 and the movable mold 220 by clamping these molds. The respective terminals 20, 30 and 40 and the respective brackets 50, 60 are arranged in the cavity C and a thermoplastic resin material as a raw material of the housing 70 is injected into the cavity C by an unillustrated injection apparatus.

The fixed mold 210 includes one or more recesses 211, into which the respective extending portions 22b, 32b and 42b of the respective terminals 20, 30 and 40 are inserted. Further, although not shown, the fixed mold 210 includes a recess, into which the fixing portion 52 of the bracket 50 is inserted.

The fixed mold 210 includes a support pin 212 projecting toward the movable mold 220 and to be inserted into the through hole 62c of the bracket 60. The support pin 212 extends in an advancing/retreating direction of the movable mold 220 with respect to the fixed mold 210.

The movable mold 220 includes a recess 221, into which the extending portion 62b of the bracket 60 is inserted. Further, although not shown, the movable mold 220 includes one or more recesses, into which the respective second connecting portions 23, 33 and 43 of the respective terminals 20, 30 and 40 are inserted.

Next, a manufacturing procedure of the terminal block 10 is described with reference to FIGS. 7 and 8. Note that, for the convenience of description, the terminal 20 and the bracket 60 are shown and described, but the terminals 30, 40 and the bracket 50 are not shown in FIGS. 7 and 8.

As shown in FIG. 7, the respective terminals 20, 30 and 40 and the respective brackets 50, 60 are first arranged in the fixed mold 210 in manufacturing the terminal block 10.

At this time, the respective terminals 20, 30 and 40 are positioned with respect to the fixed mold 210 by inserting the respective extending portions 22b, 32b and 42b into the recess(es) 211. The bracket 50 is positioned with respect to the fixed mold 210 by inserting the fixing portion 52 into the unillustrated recess. The bracket 60 is positioned with respect to the fixed mold 210 by inserting the support pin 212 into the through hole 62c.

Subsequently, the fixed mold 210 and the movable mold 220 are caused to face each other by rotating the rotary table 230. Then, as shown in FIG. 8, the fixed mold 210 and the movable mold 220 are clamped to form the cavity C. At this time, the respective embedded portions 21, 31, 41, 51 and 61 are arranged in the cavity C. Then, the resin material is injected into the cavity C by the injection apparatus. Thereafter, the housing 70 is formed by cooling and solidifying the resin material. In this way, the terminal block 10 is manufactured in which the respective terminals 20, 30 and 40, the respective brackets 50, 60 and the housing 70 are integrated.

Finally, the terminal block 10 is taken out from the fixed mold 210 and the movable mold 220.

### (Attachment Procedure of Terminal Block 10 to Case 100)

As shown in FIG. 1, in attaching the terminal block 10 to the case 100, each bolt 131 is first inserted through each first connecting portion 22, 32, 42 of each terminal 20, 30, 40 and temporarily fastened to each mating terminal 110. Further, each bolt 141, 142 is inserted through each fixing portion 52, 62 of each bracket 50, 60 and temporarily fastened to the case 100.

Subsequently, each terminal 20, 30, 40 is fixed to each mating terminal 110 by completely tightening each bolt 131.

Subsequently, each bracket 50, 60 is fixed to the case 100 by completely tightening each bolt 141, 142.

Here, as described above, the gap is formed between each fixing portion 52, 62 and the case 100 with each terminal 20, 30, 40 connected to each mating terminal 110. Thus, by completely tightening each bolt 141, 142, each bracket 50, 60 is plastically deformed toward the case 100 to fill up the gap. In this way, each bracket 50, 60 is fixed to the case 100 while being plastically deformed toward the case 100.

Finally, each second connecting portion 23, 33, 43 is fixed to each electrically conductive member 120 by each bolt 132. In this way, each second connecting portion 23, 33, 43 and each electrically conductive member 120 are electrically connected.

Here, as described above, each electrically conductive member 120 is a flexible lead wire. Thus, tolerances between each second connecting portion 23, 33, 43 and each electrically conductive member 120 are absorbed by each electrically conductive member 120.

Functions of this embodiment are described.

In the terminal block 10, the axial direction of each connection hole 22c, 32c, 42c and that of each fixing hole 52d, 62d coincide. Thus, an attachment direction of each terminal 20, 30, 40 to each mating terminal 110 and an attachment direction of each bracket 50, 60 to the case 100 coincide.

Here, the bending stiffness of each of the fixing portions 52, 62 is smaller than that of each of the first connecting portions 22, 32 and 42. Thus, by fastening each bolt 141, 142 inserted through each fixing hole 52d, 62d to the case 100 in connecting each first connecting portion 22, 32, 42 to each mating terminal 110 by each bolt 131, each fixing portion 52, 62 is easily deformed toward the case 100.

Effects of this embodiment are described.
(1) The terminal block 10 is provided with the plurality of terminals 20, 30 and 40, the plurality of brackets 50, 60 and the housing 70 made of resin, the plurality of terminals 20, 30 and 40 and the plurality of brackets 50, 60 being embedded in the housing 70. Each of the terminals 20, 30 and 40 includes the first connecting portion 22, 32, 42 projecting from the housing 70 and the second connecting portion 23, 33, 43 projecting toward the side opposite to the first connecting portion 22, 32, 42 from the housing 70. Each of the brackets 50, 60 includes the fixing portion 52, 62 projecting from the housing 70. Each of the first connecting portions 22, 32 and 42 includes the connection hole 22c, 32c, 42c, into which the bolt 131 used for connection to the mating terminal 110 is inserted. Each of the fixing portions 52, 62 includes the fixing hole 52d, 62d, into which the bolt 141, 142 used for fixing to the case 100 is inserted. The axial direction of each connection hole 22c, 32c, 42c and that of each fixing hole 52d, 62d coincide. The bending stiffness of each of the fixing portions 52, 62 is smaller than that of each of the first connecting portions 22, 32 and 42.

According to this configuration, tolerances between the terminal block 10 and the case 100 can be absorbed since the aforementioned functions are achieved.

Further, according to the above configuration, the terminal block 10 can be stably fixed to the case 100 as compared to the case where the terminal block 10 is fixed to the case 100 by only one bracket. Therefore, the vibration of the terminal block 10 with respect to the case 100 can be suppressed.
(2) The thickness of each of the fixing portions 52, 62 is smaller than that of each of the first connecting portions 22, 32, and 42.

According to this configuration, the bending stiffness of each of the fixing portions 52, 62 can be easily made smaller than that of each of the first connecting portions 22, 32 and 42.
(3) The plurality of first connecting portions 22, 32 and 42 are juxtaposed with each other in the second direction Y. The plurality of second connecting portions 23, 33 and 43 are juxtaposed with each other in the second direction Y.

According to this configuration, the size of the terminal block 10 in the third direction Z can be reduced.
(4) The first connecting portion 22, 32, 42 and the second connecting portion 23, 33, 43 in each of the terminals 20, 30 and 40 are provided at the positions different from each other in the second direction Y.

According to this configuration, even if the positions of each mating terminal 110 and each electrically conductive member 120 are different in the second direction Y, these can be electrically connected by the terminal block 10.
(5) Each of the first connecting portions 22, 32 and 42 includes the projecting portion 22a, 32a, 42a projecting in the first direction X from the housing 70 and the extending portion 22b, 32b, 42b bent from the projecting portion 22a, 32a, 42a and extending in the third direction Z. The fixing portion 62 includes the projecting portion 62a projecting toward the side opposite to each projecting portion 22a, 32a, 42a in the first direction X and the extending portion 62b bent from the projecting portion 62a and extending toward the side opposite to each extending portion 22b, 32b, 42b in the third direction Z. The projecting portion 62a includes the through hole 62c penetrating in the third direction Z.

According to this configuration, the extending portion 62b of the bracket 60 extends toward the side opposite to each extending portion 22b, 32b, 42b of each terminal 20, 30, 40 in the third direction Z. Here, in insert-molding the terminal block 10, the respective terminals 20, 30 and 40 may be positioned with respect to the fixed mold 210 by inserting the respective extending portions 22b, 32b and 42b into the recess(es) 211 of the fixed mold 210 as in this embodiment. In this case, it is difficult to position the bracket 60 with respect to the fixed mold 210 since the extending portion 62b extends toward a side away from the fixed mold 210 in the third direction Z. Thus, the bracket 60 is easily shifted in position with respect to the fixed mold 210. Such a problem is particularly notable in an apparatus in which inertial forces and vibration act on the respective terminals 20, 30 and 40 and the respective brackets 50, 60 arranged in the fixed mold 210 according to a movement of the fixed mold 210, like the manufacturing apparatus 200 of this embodiment, which is a rotary injection molding apparatus. Further, such a problem is particularly notable also when the length of the extending portion 62b of the bracket 60 is longer than that of the projecting portion 62a as in this embodiment.

In this respect, according to the above configuration, the projecting portion 62a includes the through hole 62c penetrating in the third direction Z. In this way, the bracket 60 can be easily positioned with respect to the fixed mold 210 by providing the fixed mold 210 with the support pin 212 to be inserted into the through hole 62c. In this way, the aforementioned inconvenience can be avoided.

Further, since the projecting portion 62a is provided with the through hole 62c according to the above configuration, the bending stiffness of the bracket 60 is reduced and the bracket 60 is easily deformed toward the case 100. Thus, an operation of attaching the terminal block 10 to the case 100 can be smoothly performed. Note that since the bracket 60 does not form an electrically conductive path in the terminal block 10, a reduction in the cross-sectional area of the electrically conductive path can be avoided by providing the through hole 62c in the bracket 60.

### Modifications

This embodiment can be modified and carried out as follows. This embodiment and the following modifications can be carried out in combination without technically contradicting each other.
The projecting portion 62a of the bracket 60 may include a cut serving as the through portion instead of the through hole 62c.
The shapes of the respective terminals 20, 30 and 40 and the respective brackets 50, 60 can be changed as appropriate according to the positions of the respective mating terminals 110 and the respective electrically conductive members 120 and the shape of the case 100. For example, the extending portions 22b, 32b and the 42b can be respectively omitted from the terminals 20, 30 and 40, the extending portions 52b, 52c can be omitted from the bracket 50 and the extending portion 62b can be omitted from the bracket 60. In this case, the projecting portions 22a, 32a and 42a may be respectively provided with the connection holes 22c, 32c and 42c, the projecting portion 52a may be provided with the fixing hole 52d and the projecting portion 62a may be provided with the fixing hole 62d.
Each fixing portion 52, 62 is not limited to the one projecting in the first direction X from the housing 70. Each fixing portion 52, 62 may project in an arbitrary direction from the housing 70 as long as this direction is a plane direction orthogonal to the third direction Z.
The terminal block 10 may be provided with another bracket to be fixed to the case 100 in addition to the respective brackets 50, 60.
Either one of the brackets 50, 60 may be omitted from the terminal block 10.
Each fixing hole 52d, 62d may be a long hole.
The first connecting portion 22, 32, 42 and the second connecting portion 23, 33, 43 of each terminal 20, 30, 40 may be provided at the same position in the second direction Y. In this case, each terminal 20, 30, 40 can have the same shape.
The thickness of each of the fixing portions 52, 62 may be equal to that of each of the first connecting portions 22, 32 and 42. In this case, the bending stiffness of each of the fixing portions 52, 62 may be made smaller than that of each of the first connecting portions 22, 32 and 42 by making a width of each of the fixing portions 52, 62 smaller than that of each of the first connecting portions 22, 32 and 42. Further, the bending stiffness of each of the fixing portions 52, 62 may be made smaller than that of each of the first connecting portions 22, 32 and 42 by providing each of the fixing portions 52, 62 with a through hole, a cut, a thinned portion or the like.
The terminal block 10 may be provided with two or more than three terminals.

### LIST OF REFERENCE NUMERALS

C cavity
L axis of rotation
X first direction
Y second direction
Z third direction
10 terminal block
20 terminal
21 embedded portion
21a straight portion
21b first coupling portion
21c second coupling portion
22 first connecting portion
22a projecting portion
22b extending portion
22c connection hole
23 second connecting portion
23a projecting portion
23b extending portion
23c extending portion
23d connection hole
24 nut
30 terminal
31 embedded portion
31a straight portion
31b first coupling portion
31c second coupling portion
32 first connecting portion
32a projecting portion
32b extending portion
32c connection hole
33 second connecting portion
33a projecting portion
33b extending portion
33c extending portion
33d connection hole
34 nut
40 terminal
41 embedded portion
41a straight portion
41b first coupling portion
41c second coupling portion
42 first connecting portion
42a projecting portion
42b extending portion
42c connection hole
43 second connecting portion
43a projecting portion
43b extending portion
43c extending portion
43d connection hole
44 nut
50 bracket
51 embedded portion
52 fixing portion
52a projecting portion
52b extending portion
52c extending portion
52d fixing hole
60 bracket
61 embedded portion
62 fixing portion
62a projecting portion
62b extending portion
62c extending portion
62d fixing hole
70 housing
71 first holding portion
72 second bolding portion
73 third holding portion
100 case
101 screw hole
102 resin member
103 opening
110 mating terminal
111 insertion hole
120 electrically conductive member
131 bolt
132 bolt
141 bolt
142 bolt
200 manufacturing apparatus
210 fixed mold
211 recess
212 support pin
220 movable mold
221 recess
230 rotary table

1. A terminal block for electrically connecting a plurality of mating terminals provided in a case of a device and a plurality of electrically conductive members, comprising:
a plurality of terminals made of a metal plate for electrically connecting each of the plurality of mating terminals and each of the plurality of electrically conductive members;
a bracket made of a metal plate, the bracket being fixed to the case; and
a housing made of resin, the plurality of terminals and the bracket being embedded in the housing,
each of the plurality of terminals including a first connecting portion projecting from the housing and to be connected to the mating terminal and a second connecting portion projecting toward a side opposite to the first connecting portion from the housing and to be connected to the electrically conductive member,
the bracket including a fixing portion projecting from the housing and to be fixed to the case,
the first connecting portion including a connection hole, a bolt used for connection to the mating terminal being inserted into the connection hole,
the fixing portion including a fixing hole, a bolt used for fixing to the case being inserted into the fixing hole,
an axial direction of the connection hole and that of the fixing hole coinciding, and
bending stiffness of the fixing portion being smaller than that of each of a plurality of the first connecting portions.

2. The terminal block of claim 1, wherein a thickness of the fixing portion is smaller than that of each of the plurality of first connecting portions.

3. The terminal block of claim 1, wherein:
if a projecting direction of the plurality of first connecting portions is a first direction and a direction intersecting the first direction is a second direction,
the plurality of first connecting portions are juxtaposed with each other in the second direction, and
the plurality of second connecting portions are juxtaposed with each other in the second direction.

4. The terminal block of claim 3, wherein the first and second connecting portions in each of the plurality of terminals are provided at positions different from each other in the second direction.

5. The terminal block of claim 1, comprising a plurality of the brackets.

6. The terminal block of claim 3, wherein:
if a direction orthogonal to both the first and second directions is a third direction,
the first connecting portion includes a first projecting portion projecting in the first direction from the housing and a first extending portion bent from the first projecting portion and extending in the third direction,
the fixing portion includes a second projecting portion projecting in a plane direction orthogonal to the third direction from the housing and a second extending portion bent from the second projecting portion and extending toward a side opposite to the first extending portion in the third direction, and
the second projecting portion includes a through portion penetrating in the third direction.
